(19) United States
(12) Patent Application Publication
(10) Pub. No.: US 2012/0155663 A1
(43) Pub. Date: Jun. 21, 2012

(54) FAST SPEAKER HUNTING IN LAWFUL INTERCEPTION SYSTEMS

(75) Inventors: Adam WEINBERG, Netanya (IL); Irit Opher, Kfar Saba (IL); Ruth Aloni-Lavi, Ra'anana (IL); Eyal Kolman, Tel Aviv (IL); Ido Azriel, Givatayim (IL)

(73) Assignee: Nice Systems Ltd., Ra'anana (IL)

(21) Appl. No.: 12/969,622

(22) Filed: Dec. 16, 2010

(51) Int. Cl. H04R 29/00

(52) U.S. Cl. 381/59

(57) ABSTRACT

A method for spotting an interaction in which a target speaker associated with a current index or current interaction speaks, the method comprising: receiving an interaction and an index associated with the interaction, the index associated with additional data; receiving the current interaction or current index associated with the target speaker; obtaining current data associated with the current interaction or current index; filtering the index using the additional data, in accordance with the current data associated with the current interaction or current index, and obtaining a matching index; and comparing the current index or a representation of the current interaction with the matching index to obtain a target speaker index.

### TECHNICAL FIELD

The present disclosure relates to audio analysis in general, and to a method and apparatus for speaker hunting, in particular.

### BACKGROUND

Large organizations, such as law enforcement organizations, commercial organizations, financial organizations or public safety organizations conduct numerous interactions with customers, users, suppliers or other persons on a daily basis. A large part of these interactions are vocal, or at least comprise a vocal component.

In particular, law enforcement agencies intercept various communication exchanges under lawful interception activity which may be backed up by court orders. Such communication may be stored and used for audio and meta data analysis.

Audio analysis applications have been used for a few years in analyzing captured calls. Speaker recognition is an important branch of audio analysis, either as a goal in itself or as a first stage for further processing.

Speaker hunting is an important task in speaker recognition. In a speaker hunting application there is a target speaker whose voice was captured in one or more interactions, and whose identity may or may not be known. A collection of interactions such as phone calls, the speakers in which may or may not be known is to be searched for interactions in which the specific target speaker participates. Speaker hunting is sometimes referred to as speaker spotting, although speaker spotting relates also to applications in which it is required to know at which parts of an audio signal a particular speaker or speakers speak.

Speaker hunting is thus required for locating previous or earlier interactions in which the target speaker speaks, so that more information can be obtained about that target and the interactions he participated in, without necessarily verifying his or her identity. Such an application may be useful for units that are trying to track targets who may be criminals, terrorists, or the like. Those targets may be trying to avoid being tracked by using different means, e.g. frequently replacing their phones. The application is aimed at searching the pool or previous interactions for speakers with similar voice to the target's voice.

One of the main challenges in speaker hunting is fast response time, since the application needs to scan a large number of conversations and provide the most probable interactions in a reasonable time.

On the other hand, a human inspector usually has to listen to the conversations that were indicated as having high probability to contain speech by the target speaker, and to determine whether it is indeed the target speaker. Thus, precision is important, since even a small percentage of false alarms may come up to many redundant conversations to be listened to by a user.

There is thus a need for a speaker hunting method and apparatus that can scan a large collection of speech-based interactions, such as phone calls, in order to locate interactions that possibly carry the speech of a target speaker.

### SUMMARY

A method and apparatus for speaker hunting.

One aspect of the disclosure relates to a method for spotting one or more interactions in which a target speaker associated with a current index or current interaction speaks, the method comprising: receiving one or more interactions and an index associated with each interaction, the index associated with additional data; receiving the current interaction or current index associated with the target speaker; obtaining current data associated with the current interaction or current index; filtering the index using the additional data, in accordance with the current data associated with the current interaction or current index, and obtaining a matching index; and comparing the current index or a representation of the current interaction with the matching index to obtain one or more target speaker indices. The method can further comprise generating the index associated with the earlier interaction. The method can further comprise taking an action associated with the interaction associated with the matching index. Within the method, the index optionally comprises an acoustic feature or a non-acoustic feature. Within the method, the additional data optionally comprises acoustic data. Within the method, the additional data optionally comprises non-acoustic data. The method can further comprise obtaining a comparison score. The method can further comprise outputting one or more interactions associated with the target speaker index, in accordance with the comparison results. Within the method, the representation of the current interaction is optionally an index of the current interaction.

Another aspect of the disclosure relates to an apparatus for spotting one or more interactions in which a target speaker associated with a current interaction or current index, comprising: a calls database for storing one or more interactions; an index database for storing one or more indices associated with the interactions, wherein each of the indices is associated with additional data; a filtering component for filtering the indices using the additional data, in accordance with current data associated with the current interaction or current index, and obtaining a matching index; and a comparison component for comparing the current index or a representation of the current interaction with the matching index, and obtaining a target speaker index. The apparatus can further comprise an index generation component for generating the indices associated with the interactions. Within the apparatus, the indices are optionally associated with additional data. The apparatus can further comprise an action handler for taking an action associated with one or more interactions associated with the target speaker index. Within the apparatus, any of the indices optionally comprises an acoustic feature or a non-acoustic feature. Within the apparatus, the additional data optionally comprises acoustic data or non-acoustic data. The apparatus can further comprise a user interface for outputting an interaction associated with the target speaker index.

Yet another aspect of the disclosure relates to a non-transitory computer readable storage medium containing a set of instructions for a general purpose computer, the set of instructions comprising: receiving one or more interactions and one or more indices associated with interactions, the indices associated with additional data; receiving a current interaction or current index associated with a target speaker; obtaining current data associated with the current interaction or current index; filtering the indices using the additional data, in accordance with the current data associated with the current interaction or current index, and obtaining a matching index; and comparing the current index or a representation of the current interaction with the matching index to obtain a target speaker index.

### BRIEF DESCRIPTION OF THE DRAWINGS

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 is a schematic illustration of an apparatus for speaker hunting, in accordance with the disclosure; and

FIG. 2 is a flowchart of the main steps in a method for speaker-hunting, in accordance with the disclosure.

The current application is related to US Patent Publication No. US20080195387, filed Oct. 19, 2006, and to US Patent Publication No. US20090043573 filed Aug. 9, 2007, the full contents of which are incorporated herein by reference.

Some embodiments of speaker indexing using Gaussian Mixture Modeling are disclosed for example in H. Aronowitz, D. Burshtein, A. Amir, “Speaker Indexing In Audio Archives Using Test Utterance Gaussian Mixture Modeling”, in Proc. ICSLP, 2004, October 2004, the full contents of which are incorporated herein by reference.

Some embodiments of speaker identification are disclosed for example in H. Aronowitz, D. Burshtein, “Efficient Speaker Identification and Retrieval”, in Proc. INTERSPEECH 2005, September 2005. the full contents of which are incorporated herein by reference.

A method and apparatus for speaker hunting is disclosed. The speaker hunting method is capable of matching the voice of a target speaker, such as an individual participating in a speech-based communication, such as a phone call, a teleconference or any speech embodied within other media comprising voices, to previously captured or stored voice samples.

The speaker hunting method and apparatus provide for finding a target speaker in a large pool of audio samples or audio entries of generally unknown speakers.

The method and apparatus provide a solution for locating interactions candidate to comprising speech of the target, such that the interactions are provided in real time or while the current interaction is still in progress, or any time after it was captured. The solution also provides results having low false alarm rate, which also expedites the response. The efficiency and reliability enable fast action, for example notifying law enforcement entities about the whereabouts of a wanted person, taking immediate action for stopping crimes or crime planning, or the like.

The method and apparatus combine preprocessing in which an index, which can sometimes be a model, is prepared for each speaker within each audio entry in the pool before it is required to search the pool. Once such indices are available for the pool entries, the comparison between the voice of the target as extracted from the current entry and the indices is highly efficient.

When a voice sample is captured or handled for which it is required to perform speaker hunting for a speaker, first the pool of available samples is filtered for relevant samples only, based on acoustic, non-acoustic, metadata, administrative or any other type of data. Then, for the relevant interactions only, a comparison between the interaction and the indices prepared in advance is performed in an efficient manner. The combination of cutting down the number of comparisons with increasing the efficiency of each comparison by using a pre-prepared index provides for fast results that can even be provided in real-time while the current voice entry such as a phone conversation is still going on.

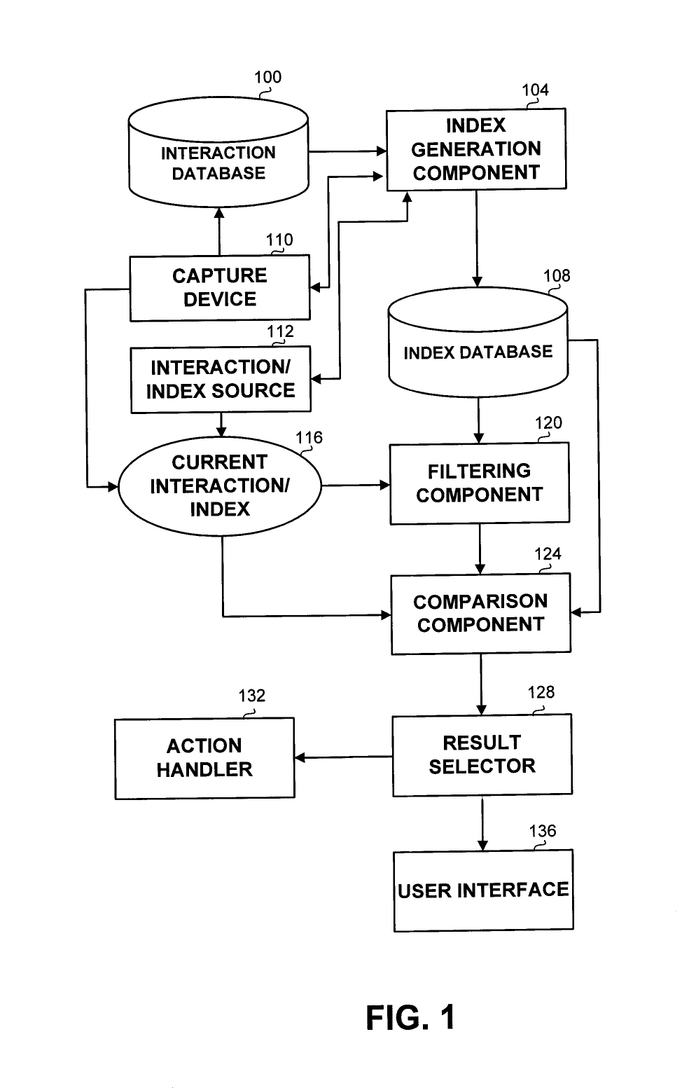

Referring now to FIG. 1, showing a schematic block diagram of the main components in an apparatus according to the disclosure.

The apparatus comprises an interaction database 100, which contains interactions, each containing one or more voice segments of one or more persons.

The interactions may be captured in the environment or received from another location. The environment may be an interception center of a law enforcement organization capturing interactions from a call center, a bank, a trading floor, an insurance company or another financial institute, a public safety contact center, a service, or the like. Segments, including broadcasts, interactions with customers, users, organization members, suppliers or other parties are captured, thus generating input information of various types, which include auditory segments, and optionally additional data such as metadata related to the interaction. The capturing of voice interactions, or the vocal part of other interactions, such as video, can employ many forms, formats, and technologies, including trunk side, extension side, summed audio which may require speaker diarization, separate audio, various encoding and decoding protocols such as G729, G726, G723.1, and the like. The interactions are captured using capturing or logging components and are stored in interaction database 100. The vocal interactions may include calls made over a telephone network, IP network. The interactions may be made by a telephone of any kind such as landline, mobile, satellite, voice over IP or others. The voice may pass through a PABX or a voice over IP server (not shown), which in addition to the voice of two or more sides participating in the interaction collects additional information. It will be appreciated that voice messages are optionally captured and processed as well, and that the handling is not limited to two-sided conversations. The interactions can further include face-to-face interactions, such as those recorded in a walk-in-center, video conferences which comprise an audio component, and additional sources of audio data and metadata, such as overt or covert microphone, intercom, vocal input by external systems, broadcasts, files, streams, or any other source.

The captured data as well as additional data is optionally stored in interaction database 100. Interaction database 100 is preferably a mass storage device, for example an optical storage device such as a CD, a DVD, or a laser disk; a magnetic storage device such as a tape, a hard disk, Storage Area Network (SAN), a Network Attached Storage (NAS), or others; a semiconductor storage device such as Flash device, memory stick, or the like. The storage can be common or separate for different types of captured interactions, different types of locations, different types of additional data, and the like The storage can be located onsite where the interactions or some of them are captured, or in a remote location. The capturing or the storage components can serve one or more sites of a multi-site organization.

The apparatus further comprises model or index generation component 104, which generates speaker indices for some or all of the interactions in interaction database 100. Generally, at least one index is generated for each speaker on each side of the interaction, whether either side of the interaction comprises one or more speakers. However, some of the interactions in interaction database 100 may be too short or of low quality, or the part of one or more speakers in a call may be too short such that an index will not be indicative. In such cases, an index is not generated for the particular call or speaker. The generated indices are generally statistical acoustic indices, but may comprise other data extracted from the audio such as spoken language, accent, gender or the like, or data retrieved, extracted or derived from the environment, such as Computer Telephony Integration (CTI) data, Customer Relationship Management (CRM) data, call details such as time, length, calling number, called number, ANI number, any storage device or database, or the like.

The generated indices are stored in index database 108, also referred to as model database, which may use the same storage or database as interaction database 100, or a different one.

It will be appreciated that index database 108 does not have to be constructed at once. Rather it may be built incrementally wherein one or more indices are constructed for each newly captured or received call as soon as practically possible or at a later time, and the relevant indices are stored in index database 108. It will also be appreciated that if different interactions contain speech segments having similar characteristics such that they may have been spoken by the same speaker, it is possible to generate only one index, based on characteristics extracted from one or more of the interactions. Thus, an index may be based on one or more segments in which the same speaker speaks, the segments extracted from one or more interactions. For example, the system can identify that the same speaker speaks in a few phone conversations, and can construct an index for this speaker using some or all of the audio segments. It will be appreciated that the segments used for constructing an index can be extracted from different interactions, according to predefined rules relating to the quality and length of the segments.

Optional capture device 110 captures interactions, and particularly incoming interactions, within an interaction-rich organization or an interception center, such as an interception center of a law enforcement organization, a call center, a bank, a trading floor, an insurance company or another financial institute, a public safety contact center, an internet content delivery company with multimedia search needs or content delivery programs, or the like. Segments, including broadcasts, interactions of any type including interactions with customers, users, organization members, suppliers or other parties are captured, thus generating input information of various types. Capturing may have to be performed under a warrant, which may limit the types of interactions that can be intercepted, the additional data to be collected, or apply any other limitations.

The information types optionally include auditory segments, video segments, textual interactions, and additional data. The capturing of voice interactions, or the vocal part of other interactions, such as video, can employ many forms, formats, and technologies, including trunk side, extension side, summed audio, separate audio, various encoding and decoding protocols such as G729, G726, G723.1, and the like. The vocal interactions usually include telephone, microphone or voice over IP sessions. Telephone of any kind, including landline, mobile, satellite phone or others is currently the main channel for communicating with users, colleagues, suppliers, customers and others in many organizations. The voice typically passes through a PABX (not shown), which in addition to the voice of two or more sides participating in the interaction collects additional information discussed below. A typical environment can further comprise voice over IP channels, which possibly pass through a voice over IP server (not shown). It will be appreciated that voice messages are optionally captured and processed as well, and that the handling is not limited to two or more-sided conversations, for example single channel recordings. The interactions can further include face-to-face interactions, such as those recorded in a walk-in-center, video conferences which comprise an audio component, and additional sources of data. The additional sources may include vocal sources such as microphone, intercom, vocal input by external systems, broadcasts, files, streams, or any other source. Additional sources may also include information from Computer-Telephony-Integration (CTI) systems, information from Customer-Relationship-Management (CRM) systems, or the like. The additional sources can also comprise relevant information from the agent's screen, such as events occurring on the agent's desktop such as entered text, typing into fields, activating controls, or any other data which may be structured and stored as a collection of screen events rather than screen capture. Data from all the above-mentioned sources and others is captured and may be logged by capture device 110, and may be stored in interaction database 100.

Alternatively, interaction or index source 112 may receive interaction or index from any source such as index database 108, a previously recorded interactions or others, and provide current interaction or index 116 which contains the voice of a speaker or a representation thereof. Current interaction or index 116 can be captured and handled as a stream while it is still in progress, or as a file or another data structure once the interaction ended.

Current interaction or index 116 and additional data if available, are input into optional filtering component 120 which selects the relevant call indices to be compared to out of index database 108, and outputs the indices matching the filter definitions. In some embodiments, filtering component 120 may initiate a query to be responded by index database 108, or any other mechanism. The indices are selected, i.e., a reduced set of indices is returned, based upon acoustic and/or non-acoustic characteristics extracted from the audio of current interaction 116, or upon additional data, such as CTI data, calling, speaker gender, or the like.

One or more patterns associated with the above data or other parameters, representing prior knowledge regarding the target can also be generated and used.

Index selection can also be run as an alert in an automatic mode, wherein multiple alerts can be executed in parallel. This can be useful when alerts are intended for “high profile” searches that need to be done, for example when it is required to locate a missing person, to hunt a specific criminal speaking with financial institutes, or the like.

In some embodiments, an index can be generated based on current interaction 116.

Current interaction or index 116 comprises a full or part of a captured interaction captured in the environment, or a combination of two or more such interactions or parts thereof. In yet another alternative, current interaction or index 116 can be an existing index rather than one or more interactions or parts thereof The index may have been constructed from data received from one or more various sources, and may be based, for example on one on more interactions or parts thereof

Either capture device 110 or interaction or index source 112 can communicate with index generation component 104 generate an index for a received or captured interaction. The index can be stored within index database 108.

The generated index, as well as the relevant indices as identified by filtering component 120 are input into comparison component 124 which compares the index based on current interaction 116 or parts thereof that relate to a particular speaker with each of the indices output by filtering component 120. Comparison component 124 provides for one or more speakers of current interaction 116 and for each index provided by filtering component 120, a probability score that the target speaker of current interaction 116 is the person upon whose speech the index was generated.

However, outputting the indices associated with the higher scores may not be enough, and it may be required to output the interactions upon which the indices were generated.

It will be appreciated that comparison component 124 can utilize a hierarchical structure of the indices, by first comparing against a top-level set of indices, and only if the comparison indicates high similarity, further sub-indices are checked.

The results of comparison component 124 are input into result selector 128 which selects the interactions to be output. The selected interactions may include all interactions for which the probability score exceeds a predetermined threshold, a predetermined number of interactions for which the probability score was highest, a predetermined percentage of the interactions having the highest scores, or the like.

The selected interactions may be transferred to action handler 132 for taking an action such as sending a notification to a law enforcement organization, sending a message to a person handling the current interaction if the interaction is still in progress, or any other action.

The selected interactions may also be transferred to any other system or component, such as user interface 136 which enables a user to listen to the interactions selected by result selector 128 and to determine whether the target speaker indeed speaks in any one or more of the selected interactions. In some embodiments, the search can also be initiated by a user from user interface 136.

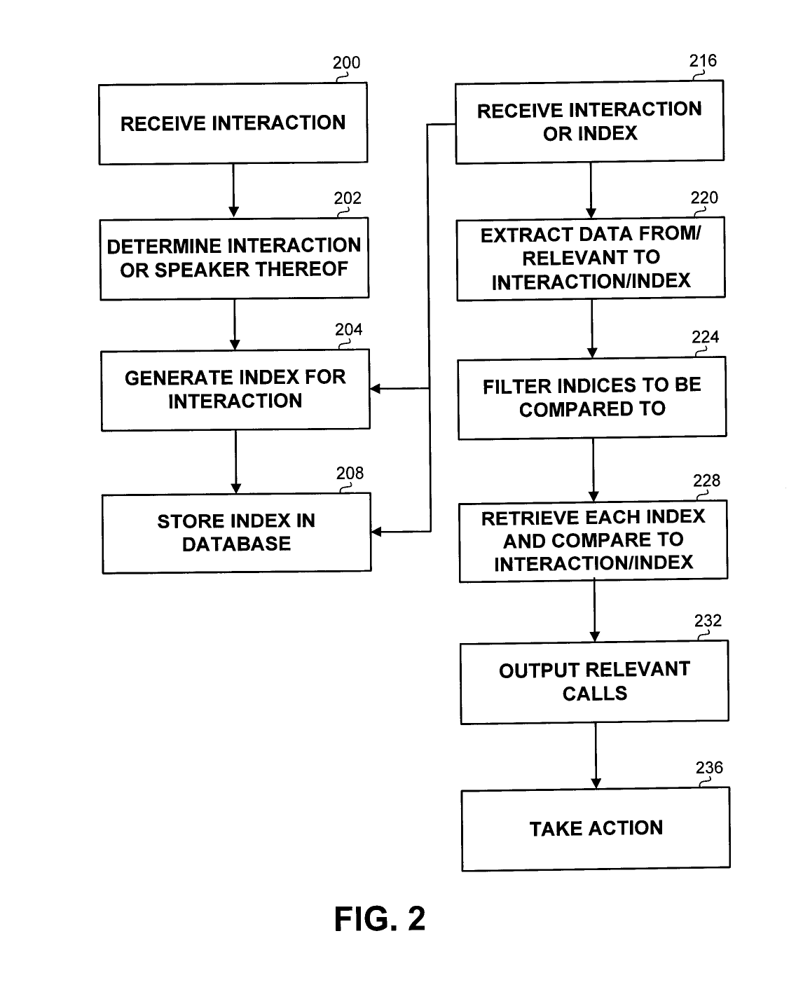

Referring now to FIG. 2, showing a schematic flowchart of the main steps in a method for speaker hunting.

On step 200 an interaction is received, in which one or more speakers' voice appears. The interaction can be captured as it is still going on, or at a later time, after it was completed. The received interaction can also comprise parts of multiple interactions, for example parts of different interactions in which the same speaker speaks. On optional step 202 one or more speakers in the interaction are determined for which an index should be generated. Optionally, an indication can be received for which speakers in the interaction indices are to be generated. For example, such indication can be supplied using a dedicated application which lets a user indicate a speaker for which an index is to be generated. In other alternatives, indices are automatically generated for all speakers in the interaction.

On index generation step 204, an index is generated for at least one speaker in the interaction received on step 200, provided that the audio is suited for index generation, for example it is of sufficiently high audio quality. Optionally, the index is a statistical index. The statistical index can be of different types according to the recognition algorithm being used.

For example, if the recognition is based on comparing the acoustic features from the conversation frames with an acoustic Adapted Gaussian Mixture Model (AGMM), the index can contain a set of acoustic frame features and the N-best Gaussians of each frame. In other embodiments, when the algorithm used for recognition is based on a Super Vector algorithm, an AGMM (also referred to as super index) is created for each conversation, and during recognition the super vectors are compared.

In yet another embodiment, the index indicates the distribution of n-gram phoneme or words, and during recognition these parameters are compared.

It will be appreciated that either one of the above exemplary recognition methods, or additional ones can be used alone or in combination.

The extracted characteristics may include but are not limited to acoustic features, prosody features, language identification, age group, gender identification, emotion, noise type, channel type, or the like. The index or model can be an AGMM or another statistical index like support vector machine (SVM), neural network, word lattice, phoneme lattice which may comprise triphones, biphones, or other word parts.

It will be appreciated that the generated indices can also be used in a hierarchical search system. The created statistical indices can be hierarchically grouped according to their similarity or to any other criterion for example based on metadata. In such case, when later searching for a speaker, the search can be executed also in a hierarchical manner that compares only the indices that belong to the same group/s as the target index. For instance, the channel and noise environment of the created indices can be characterized in accordance with their distance from different background indices, followed by grouping them in accordance with their channel and/or noise type, for example transient noises or strong echo. Such hierarchical usage will also decrease the query response time.

In some embodiments, multiple indices may be prepared for each speaker, for example using voice samples that were recorded using different devices. Such indices can be used in hierarchical or step-wise search. For example, three indices can be available for a multiplicity of speakers: a cell phone index, a landline index, and a combined index. When an interaction is received, the device type is identified first, and then the search continues only for indices associated with the same device type, as detailed below.

It will be appreciated that the statistical stored information about each conversation can also be used for other audio analysis such as Automatic Speech Recognition tasks. For example, a query can be executed which locates conversations in a specific language.

Also associated with each generated index is additional data, which may be used for filtering indices so that fewer comparisons will be required for each interaction. The additional data may be acoustic, non-acoustic or relate to operational scenario.

In some embodiments, multiple indices can be generated for the same speaker, as detailed in association with step 228 below.

On step 208 the generated index or model and additional data is stored in index database. Optionally, one or more indices received from external sources, with or without the interactions upon which the indices were constructed, may also be stored in the index database.

On step 216, a current interaction or current index is received, for which there is a need to find additional interactions in which one or more of the speakers associated with the current interaction or current index participates. Optionally a user can indicate for which speaker in the interaction it is required to find earlier interactions. The current interaction can also be comprised of a multiplicity of interactions or parts thereof.

Optionally, if a current index is received then it is stored, and if a current interaction is received, an index is generated and then stored.

On step 220, data associated with the current interaction or the current index is received or extracted, such as calling number CTI information, claimed or known identity of one or more speakers of the interaction, or the like. Also, data can be extracted from the interaction itself, such as speaker gender, speaker age, language, one or more words spoken in the interaction, or the like. The data extracted can thus contain acoustic as well as non-acoustic parameters, obtained form acoustic as well as non-acoustic sources. The data can reflect knowledge about the target, such as age or gender as extracted from the audio, or other information extracted or derived from the audio or from other sources such as CDR, XDR, CTI or organizational database. The data may include nationality, family status, working place, areas he or she are usually at on different times of the day, times he usually makes phone calls, frequent phone connections, or the like. One or more patterns of the above data or other parameters, representing prior knowledge regarding the target can be generated.

Searching for interactions of the speaker may require the matching of specific parameters, or just taking them into account. For example, if it is known that the target speaks French, then search can be performed for French interactions only, or if it is known that the target usually speaks on afternoons, calls made in the afternoon can be assigned higher score. However, this is not compulsory, and such data can be used to assign different weights to the searched calls rather than limit them. In a different scenario, if the target makes calls from one or more known telephone numbers, it may still be required to search for calls made from other telephones, in order to determine the number of a new phone he or she is using.

On filtering step 224, the models or indices are filtered in accordance with the data associated with or extracted from the current interaction or current index on step 220. Only the matching indices output by filtering step 224 are later compared on comparison step 228. Filtering requires comparing the data associated with or extracted from the interaction, with data related to each index stored in index database. Each compared field can be indicated as compulsory or non-compulsory. For example, gender can be compulsory—when the target is a male, no point in looking for female voices, and vice versa. Calling number can be non-compulsory since a target can call from additional phones. In some embodiments, each index may receive a temporary score based on the degree it matches the characteristics of the target. In some embodiments, only indices that received a temporary score exceeding a threshold, or only the predetermined number of interactions that received the top score, or only a predetermined percentage of the interactions that received the top score, or only the indices that satisfy any other limiting condition, are then compared on comparison step 228.

Using the filtering score may be associated with the balance between the required precision and false alarm rate. For operational scenarios that need high recall, a relatively low score threshold may be set so that many interactions will be returned. If the operational scenario requires a low false alarm rate, the score threshold is set to a higher level so that fewer interactions are returned. The operational scenario can also dictate one or more filters related to the warrant under which interactions may be collected, such as limitation to particular phone number, geographical region, or the like.

Thus, filtering step 224 filters out the indices in index database that do not match the query or the defined operational scenario.

For example, suppose the target speaks French, and it is required to locate a new phone number he is calling from. Then at first only indices in which the language is French will be used, followed by additional filtering which used a high threshold so that only few interactions will be returned, thus reducing the risk of false alarms and accelerating the process.

On step 228 the indices output by filtering step 224 are retrieved and compared against the interaction or interactions or the index provided.

The comparison is a mathematical comparison between indices or statistical representations of the speaker voices in, and depends on the type of index or model used. For example, if AGMM models are used, the comparison can relate to the distance between the acoustic frames of the current interaction and any of the filtered models. If super vectors are used, the system can determine the distance between the super vector index of the current interaction and any of the filtered indices. It is also possible to combine any of the above mentioned scoring mechanisms or other scoring mechanisms.

In some embodiments, two or more indices can be constructed for one speaker, wherein each index is based on interactions captured in different environments. For example, one interaction is over a landline while the other is over GSM. At comparison step 228 the voice sample is compared separately against the two or more indices, wherein the comparison score may take into account the environmental similarity or difference between the voice sample and the index. The scores of the two or more comparisons can then be combined in any way, such as summing the scores, averaging the scores using some weights, or the like.

In some embodiments, all indices for which the score of comparison with the target exceeds a predetermined threshold are output. In other embodiments, only a predetermined number of indices, or a predetermined percentage of the indices is returned.

It will be appreciated that some parameters or features can be regarded either as metadata and used for filtering interactions on step 224, or as part of the generated index and be used in comparison step 232. Thus, the speaker's gender can be used as metadata, such that only indices of the same gender will be filtered for comparison, or only specific frequencies will be compared when the relevant index is compared to the target speech. It is generally preferred to filter in accordance with such data at an early stage and reduce the number of indices to be compared, but some embodiments may he used in which it is better to compare more indices.

On step 232 the relevant interactions, i.e., the interactions associated with the indices having the highest scores as output by comparison step 228 are output to any required purpose and in any required format. For example the interactions can be output to an application that enables a listener to listen and compare the voice in each interaction to the voice of the target, to an application that performs a more thorough voice comparison, activates automatic speech recognition (ASR) application, or the like.

On optional step 236, an action is taken, such as sending a message to an agent handling the interaction in which the target speaker speaks, calling a law enforcement agency, calling emergency services, or the like.

It will be appreciated that the process can be initiated automatically to provide alerts, or manually by a user.

It will be appreciated that the components of the disclosed apparatus and the steps of the disclosed method can be implemented as one or more inter-related collections of computer instructions, such as executables, services, static libraries, dynamic libraries or the like, which are designed or adapted to be executed by a computing platform such as a general purpose computer, a personal computer, a mainframe computer, or any other type of computing platform that is provisioned with a memory device (not shown), a CPU or microprocessor device, and several I/O ports (not shown).

The computer instructions, can be programmed in any programming language such as C, C++, C#, Java or others, and developed under any development environment, such as .Net, J2EE or others. Alternatively, the apparatus and methods can be implemented as firmware ported for a specific processor such as digital signal processor (DSP) or microcontrollers, or can be implemented as hardware or configurable hardware such as field programmable gate array (FPGA) or application specific integrated circuit (ASIC). The computer instructions can be executed on one platform or on multiple platforms wherein data can be transferred from one computing platform to another via a communication channel, such as the Internet, Intranet, Local area network (LAN), wide area network (WAN), or via a device such as CDROM, disk on key, portable disk or others.

The disclosed method and apparatus combine the pre-generation of speaker indices, with filtering of indices according to acoustical and/or non-acoustical features.

The pre-generation of speaker indices for all calls in the database provides for availability of indices when it is required to spot interactions in which a target participates, so that faster comparison can be performed, so there is no need to generate an index in real-time. Comparing two indices is faster than comparing the characteristics such as features extracted from two voices, and faster than comparing a set of features to an index.

Also, it is not necessarily required to generate an index for the target speaker, which also accelerates the process. However, it will be appreciated that the disclosed method and apparatus can be enhanced to generate an index also from the target speaker's voice, and then compare this index to each of the indices output by the filtering step, since comparing two indices is faster than comparing two voices. A single CPU can compare hundreds of thousands of indices every minute. Filtering indices provides for reducing the initial pool size so that fewer indices are compared to the voice of the target, thus also accelerating the process. The usage of acoustic, non-acoustic or work-scenario-related parameters provides for effective reduction in the pool size, which can dramatically reduce the number of false alarms by avoiding similar conversations, as well as increasing the real time performance.

Early, real-time, or near real-time provisioning of interactions in which the target speaker speaks, enables taking timely actions once additional information about the target, such as but not related to his or her identity, phone number or others are known.

It will be appreciated by persons skilled in the art that the present invention is not limited to what has been particularly shown and described hereinabove. Rather the scope of the present invention is defined only by the claims which follow.

What is claimed is:

1. A method for spotting at least one interaction in which an at least one target speaker associated with a current index or current interaction speaks, the method comprising:
receiving at least one interaction and an at least one index associated with the at least one interaction, the at least one index o associated with additional data;
receiving the current interaction or current index associated with the at least one target speaker;
obtaining current data associated with the current interaction or current index;
filtering the at least one index using the additional data, in accordance with the current data associated with the current interaction or current index, and obtaining a matching index; and
comparing the current index or a representation of the current interaction with the matching index to obtain at least one target speaker index.

2. The method of claim 1 further comprising generating the at least one index associated with the at least one interaction.

3. The method of claim 1 further comprising taking an action associated with the at least one interaction associated with the matching index.

4. The method of claim 1 wherein the at least one index comprises an acoustic feature.

5. The method of claim 1 wherein the at least one index comprises a non-acoustic feature.

6. The method of claim 1 wherein the additional data comprises acoustic data.

7. The method of claim 1 wherein the additional data comprises non-acoustic data.

8. The method of claim 1 further comprising obtaining a comparison score.

9. The method of claim 1 further comprising outputting the at least one interaction associated with the at least one target speaker index, in accordance with the comparison results.

10. The method of claim 1 wherein the representation of the current interaction is an index of the current interaction.

11. An apparatus for spotting an at least one interaction in which an at least one target speaker speaking associated with a current interaction or current index, comprising:
a calls database for storing an at least one interaction;
an index database for storing an at least one index associated with the at least one interaction, wherein the at least one index is associated with additional data;
a filtering component for filtering the at least one index using the additional data, in accordance with current data associated with the current interaction or current index, and obtaining a matching index; and
a comparison component for comparing the current index or a representation of the current interaction with the matching index, and obtaining a target speaker index.

12. The apparatus of claim 11 further comprising an index generation component for generating the at least one index associated with the at least one interaction.

13. The apparatus of claim 11 wherein the at least one index is associated with additional data.

14. The apparatus of claim 11 further comprising an action handler for taking an action associated with the at least one interaction associated with the target speaker index.

15. The apparatus of claim 11 wherein the at least one index comprises an acoustic feature.

16. The apparatus of claim 11 wherein the at least one index comprises a non-acoustic feature.

17. The apparatus of claim 11 wherein the additional data comprises acoustic data.

18. The apparatus of claim 11 wherein the additional data comprises non-acoustic data.

19. The apparatus of claim 11 further comprising a user interface for outputting at least one interaction associated with the target speaker index.

20. A non-transitory computer readable storage medium containing a set of instructions for a general purpose computer, the set of instructions comprising:
receiving at least one interaction and an at least one index associated with the at least one interaction, the at least one index associated with additional data;
receiving a current interaction or current index associated with a target speaker;
obtaining current data associated with the current interaction or current index;
filtering the at least one index using the additional data, in accordance with the current data associated with the current interaction or current index, and obtaining a matching index; and
comparing the current index or a representation of the current interaction with the matching index to obtain at least one target speaker index.
